(19) United States
(12) Patent Application Publication
(10) Pub. No.: US 2007/0037127 A1
(43) Pub. Date: Feb. 15, 2007

(54) Method of forming pressable procelain restoration

(75) Inventors: Robert Ibsen, Santa Maria, CA (US); Thomas C. Chadwick, Nipomo, CA (US); Rebecca K. Santiago, Santa Maria, CA (US); Jianxun Feng, Santa Maria, CA (US)

Correspondence Address: CROWELL & MORING LLP;INTELLECTUAL PROPERTY GROUP, P.O. BOX 14300, WASHINGTON, DC, 20044-4300, US

(73) Assignee: DEN-MAT CORPORATION

(21) Appl. No.: 11/498,264

(22) Filed: Aug. 3, 2006

Related U.S. Application Data
(60) Provisional application No. 60/705,448, filed on Aug. 5, 2005.

(51) Int. Cl. A61C 5/10

(52) U.S. Cl. 433/223

(57) ABSTRACT

A method of making pressable porcelain restorations. A predetermined amount of porcelain powder is provided to a refractory mold in a lost wax method. The powder may be a blend of different colored powders in order to provide a restoration of a particular shade.

### BACKGROUND

1. Field of the Invention

The invention relates to the dental arts and the ceramic arts.

2. State of the Art

Dental restorations are well known in the art. Common dental restorations include inlays, onlays, crowns, and veneers. One method of forming dental restorations involves using the lost wax technique. The lost wax technique is a well-known method in the metallurgical sciences wherein a wax or polystyrene model is replaced by molten metal. In the case of dentistry, the wax model is replaced by ceramic after the wax is burned out.

The formation of a dental restoration by the lost wax technique previously required the following steps:

1. Tooth preparation: In this step a portion of the tooth was removed, for example the removal of 1.5 to 2 mm of tooth structure, i.e., enamel or dentin. This step was necessary to provide a preparation of the tooth without undercuts and to allow for a final metal ceramic or metal resin restoration that was of adequate thickness.

2. Impression (negative mold): An impression material such as a hydrocolloid, polyester rubber, or vinyl polysilicone (VPS) was used to make an impression of the prepared teeth.

3. Stone model formation: The impression was then used by the laboratory technician to create a stone or epoxy model with removable dies that were an accurate copy of the prepared tooth, i.e., to create a positive replication of the tooth (see FIG. 1).

4. Spacer application: A die spacer was then applied to the die, which affords appropriate relief in a range of 20 to 36 microns to allow space for a dental cement or bonding agent to secure the final restoration to the patient's prepared tooth (see FIG. 2).

5. A lubricant or a release agent was then placed over the die spacer.

6. Wax up: A wax model of the dental restoration was then fabricated over the lubricated die. That is, the wax was built up over the stone model of the tooth to the desired dimension of the final restoration (see FIG. 3).

7. Investing/Casting: The wax pattern was then removed from the stone model and invested in high heat investment or refractory material and cast from a molten metal using the “lost wax” technique and a centrifuge process to form a metal coping or substructure of the restoration.

8. The ceramic or visible portion of the restoration was then formed by applying and baking successive layers of ceramic powders mixed with distilled water or other types of ceramic building-up liquids, first to opaque over the metal coping to hide the metal color and then to shape the ceramic from its various transition shades to create as natural an appearance as possible. The temperatures of this baking were a function of individual vendor's particular protocol.

An improvement on this technology was the development of pressable all-ceramic restorations. These restorations, which eliminated the use of metal, are so named because the ceramic is pressed into a void in the refractory material. In the first step of this process, a wax model of the final restoration or veneer is formed by the method described above in steps 1-6. The model is then mounted on a pedestal connected to a ring former base. The model is mounted on the pedestal using a wax sprue (see FIG. 4). Several restorations can be mounted on a single pedestal using one sprue per restoration. The sprues are generally mounted at an angle of between 30° and 60° with respect to the upper surface of the pedestal. The pedestal and sprue elevate the model up from the ring former base, suspending the model in the air. In order to determine the amount of ceramic required to form the restoration, the model(s) and sprue(s) are weighed. This is typically accomplished by weighing the ring former/pedestal without the sprues and models, weighing ring former/pedestal and sprues and models together, and then subtracting the former from the latter.

A ring is then placed around the pedestal on the ring former base. The ring fits snugly on a raised portion of the ring former base (see FIG. 5). The ring completely encompasses the pedestal, sprues, and models. Typically, at least 10 mm clearance is provided for all around the model(s) by the ring, which is typically made of paper but can also be made of an elastomer. The size of the ring is typically chosen based on the determined weight of the wax. A stabilizer ring may be placed over the upper rim of the ring in order to provide additional support (see FIG. 6). The ring is then filled with a castable refractory material, also known as investment. Typically, the ring volume is slowly filled to ensure there is minimal formation of air bubbles in the investment material. Typically, all areas of the mold form that are to come into contact with the refractory material are lubricated to prevent adhesion to the refractory. Typically, petroleum jelly or a Teflon-Silicone spray are used as lubricants.

The refractory material is then allowed to solidify resulting in a refractory material cylinder. Typically, solidification requires at least a half hour of set time. The refractory material cylinder is then removed from the ring former base/pedestal and the leveling ring. This is typically accomplished by twisting the base/pedestal and the leveling ring so as to break away the refractory material from the surfaces of each. The paper ring is then removed. Any roughness on the mold is then removed by a cutting instrument. The paper ring may also leave a seam down the side of the refractory material cylinder. This seam can be smoothed in a similar manner.

The refractory material cylinder encompassing the wax sprue(s) and model(s) is then placed in a burnout furnace or oven. The cylinder is placed with the pedestal opening down. The burnout oven is typically set at around 900° C. In this heated environment, the wax composing the sprue(s) and model(s) melts and then burns or evaporates off through the void created by the pedestal. A cylinder of the refractory material remains with a negative of the shape of the model connected to a passageway, created by the void left by the pedestal, via the void left by the sprue. The pedestal can also be made of wax and detachable from the ring former base. In this case, the pedestal is not lubricated and does not break off with the base but remains inside the refractory material cylinder. The wax pedestal is then burned off as described above leaving the void described above.

Ceramic is then pressed into the model negative (restoration mold) through the void left by the pedestal. This is typically accomplished by first selecting the amount and size of ceramic ingots needed to form the restoration. This is calculated based on the measured wax weight. Typically, ceramic ingot manufacturers provide charts correlating the size and number of ingots to use with the measured weight of the wax. The ceramic ingot is then placed into the hole in the refractory cylinder. A plunger is then placed into the hole above the ceramic (see FIG. 7). The plunger is typically made of aluminum oxide although other refractory materials may be used. The plunger is then used to force the ceramic into the restoration mold. The pressing process typically stops when ceramic fills the voids left by the model and the sprue. This whole process typically takes place in a press furnace. The pressing of the ceramic typically takes place under a high vacuum and at high temperatures up to 1200° C. (2192° F.). Press furnaces can be preprogrammed with certain heating and vacuum press cycles for different types and amounts of ceramic. The ceramic ingot and plunger may also be preheated before being placed into the refractory cylinder.

After the mold is removed from the press furnace and cooled, the next step involves the divesting of the refractory material cylinder from the ceramic restoration. This is typically accomplished by cutting the refractory cylinder with a separating disk at the point where the bottom of the plunger lies. This point is estimated by placing an identical plunger next to the embedded plunger and marking on the refractory cylinder surface the end of the plunger (see FIG. 8). The cylinder is cut all along its circumference and then the material is pried off using a plaster knife or similar tool. The remaining investment material is then removed with a sandblaster using a suitable abrasive such as alumina, quartz, or glass beads.

The sprue is then removed from the restoration by cutting the sprue near its base using a diamond disk (see FIG. 9). The remaining material is then removed using a ceramic stone or other abrasive. The ceramic restoration can then be fit on the stone model after removing the spacer and acute adjustments can be made as required.

In the formation of porcelain veneers, most manufacturers use solid, fully mature, cylindrical ingots as the source of porcelain. These ingots are then pressed into the refractory mold by the method described above. However, these fully mature ingots are expensive and time consuming to manufacture and the processes for making them do not lend themselves to extremely high volume production. Therefore, there remains a need for a porcelain restoration process that does not require the use of ingots. There further remains a need for a porcelain restoration process that is cheaper, less time consuming, and allows high volume production. There further remains a need for a porcelain restoration process that allows real time control of the shade of porcelain in the restoration.

### SUMMARY OF THE INVENTION

One embodiment of the invention includes a method for making a pressable porcelain restoration for a tooth. A wax model of a tooth is formed. A refractory material structure is then formed around the wax model. The wax of the wax model is then removed from within the refractory material structure to form a void in the shape of the wax model within the refractory material structure. A predetermined amount of porcelain powder is pressed into the void to fill the void forming a porcelain powder compact in the shape of the void. The refractory material structure is removed from around the porcelain powder compact to form a porcelain restoration.

Another embodiment of the invention is a method for making a porcelain restoration of a desired shade. A refractory material mold in the shape of the restoration is provided. A plurality of different colored porcelain powders are pressed into the mold to fill the mold with porcelain forming a polychromatic porcelain powder compact in the shape of the mold. The refractory material is removed from around the polychromatic porcelain powder compact to form a porcelain restoration of a desired shade.

### BRIEF DESCRIPTION OF THE DRAWINGS

FIG. 1 shows a stone model of a patient's teeth.

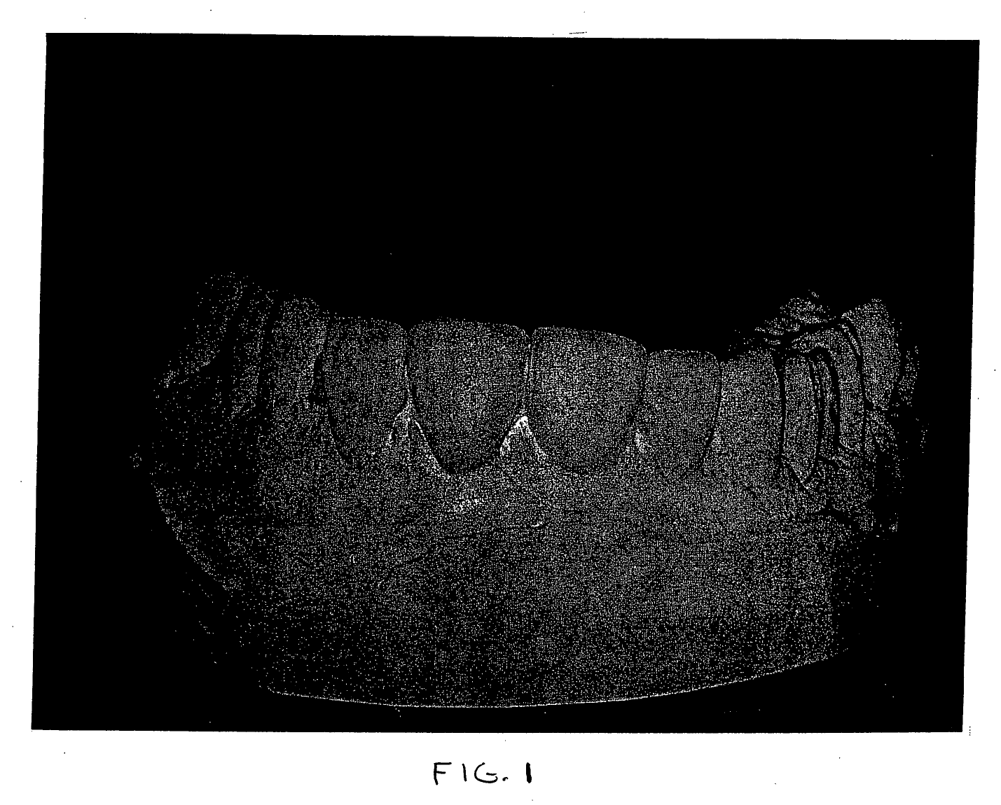

FIG. 2 shows a die spacer applied to the tooth model.

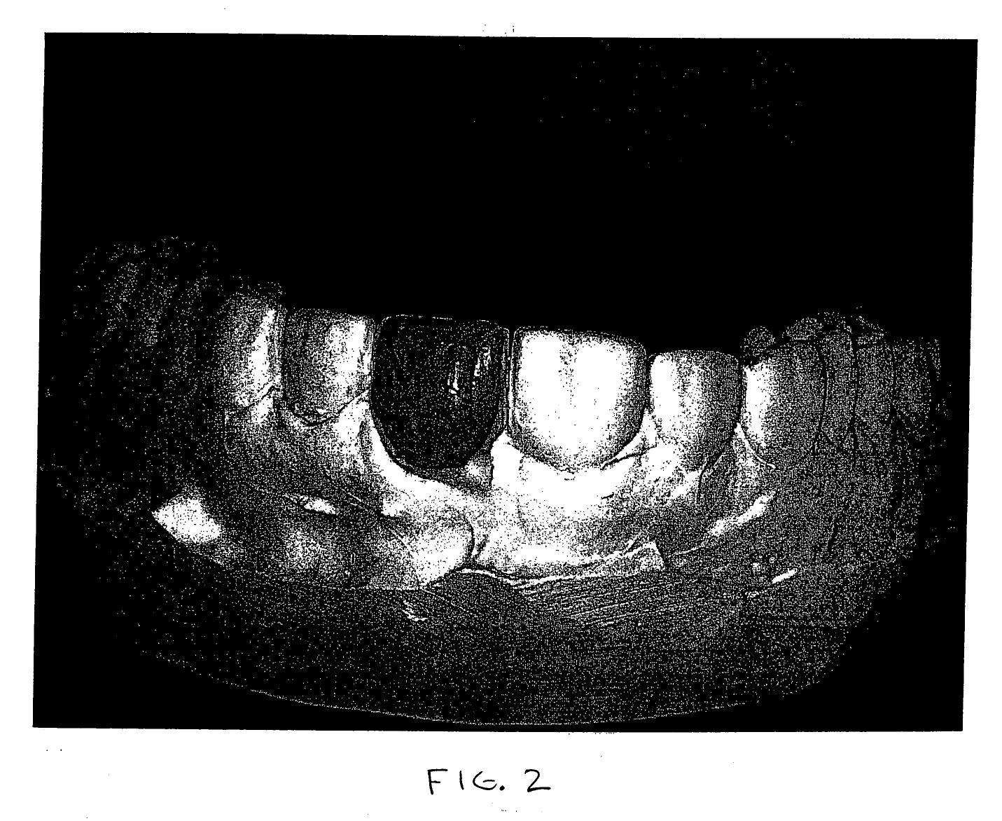

FIG. 3 shows the creation of the wax model of the dental restoration.

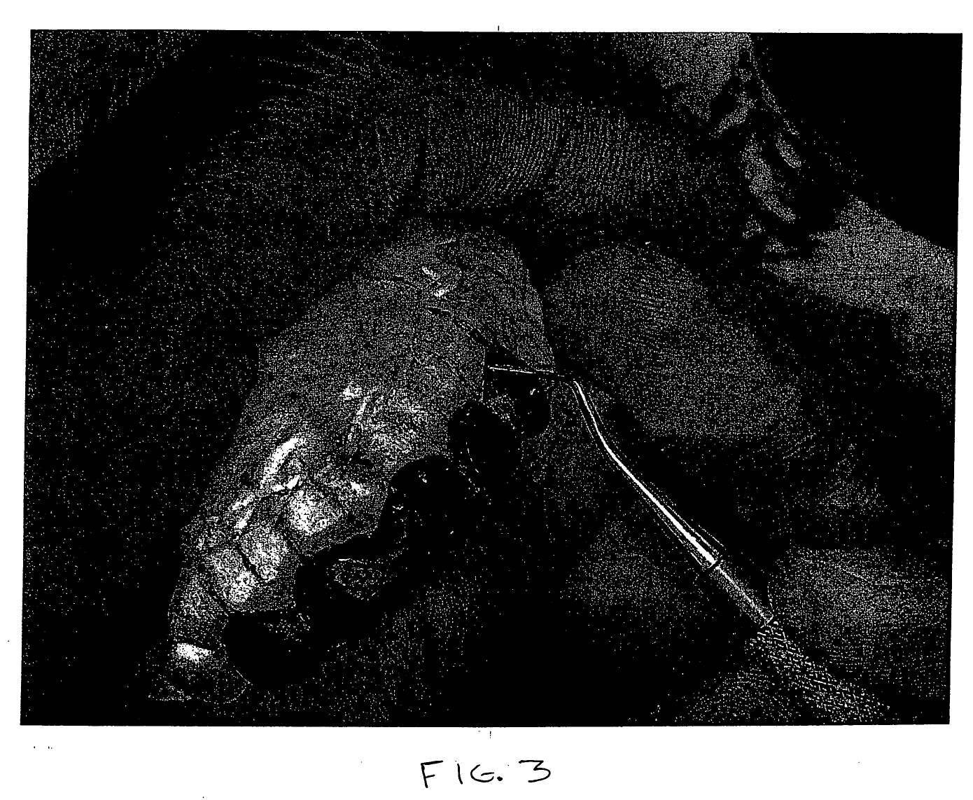

FIG. 4 shows the mounting of the wax models to a pedestal/ring former base using wax sprues.

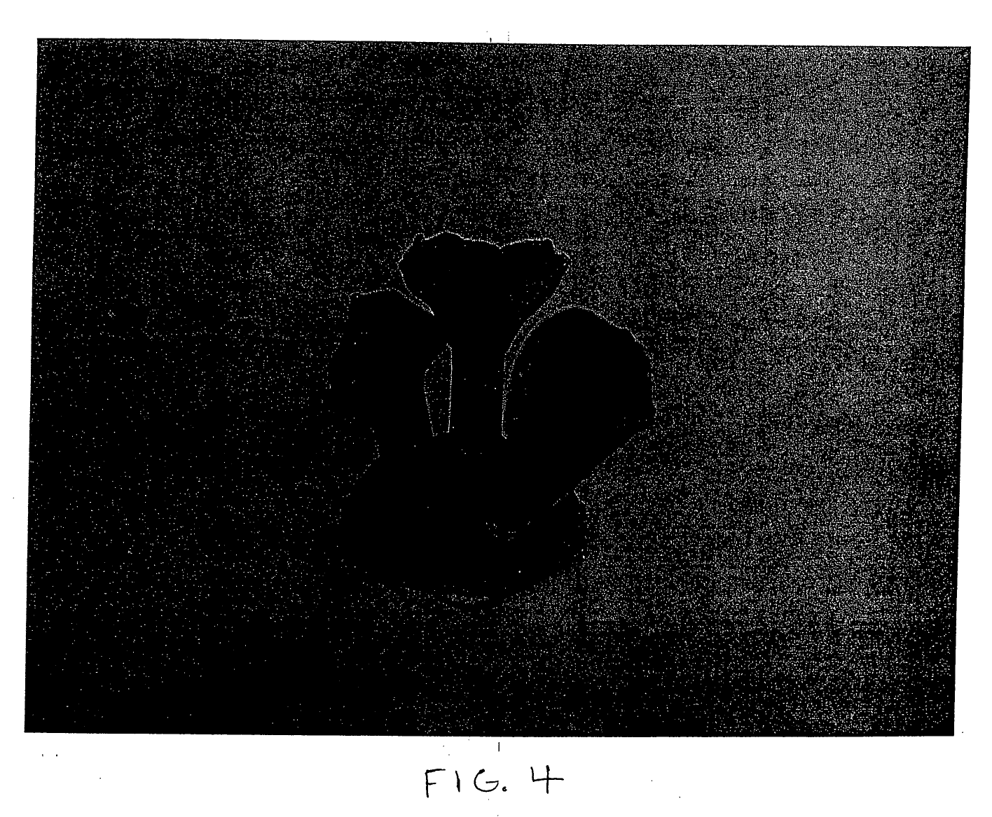

FIG. 5 shows the tight fit between the ring former base and a ring.

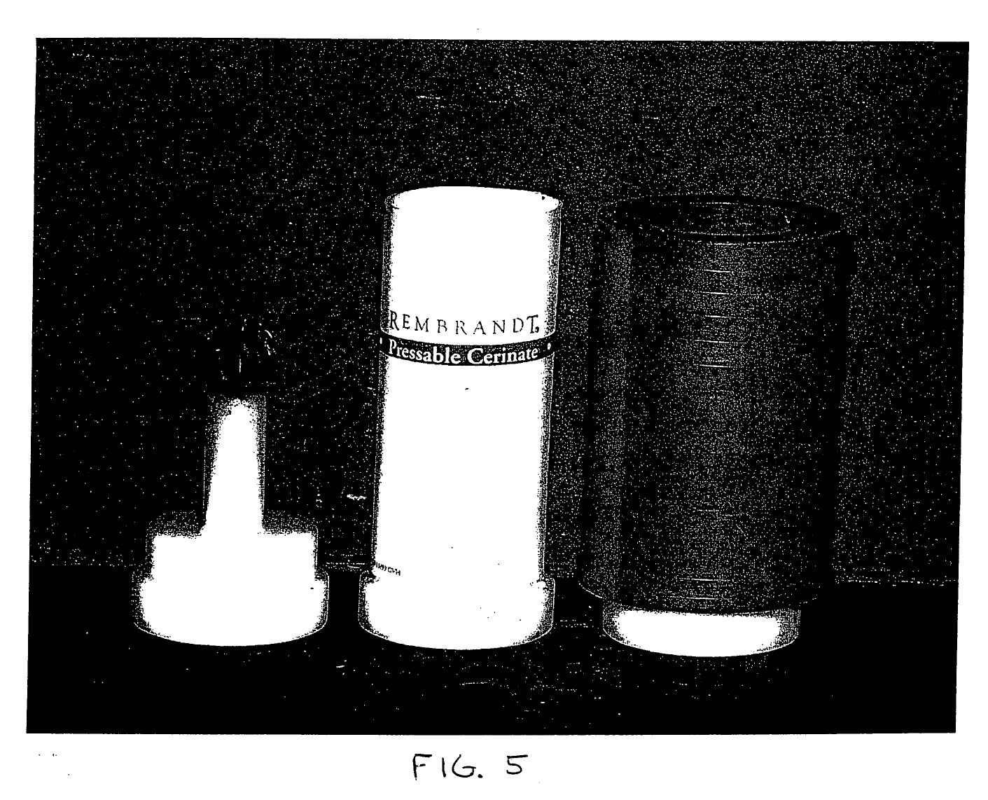

FIG. 6 shows the application of a stabilizer ring to the upper rim of the ring.

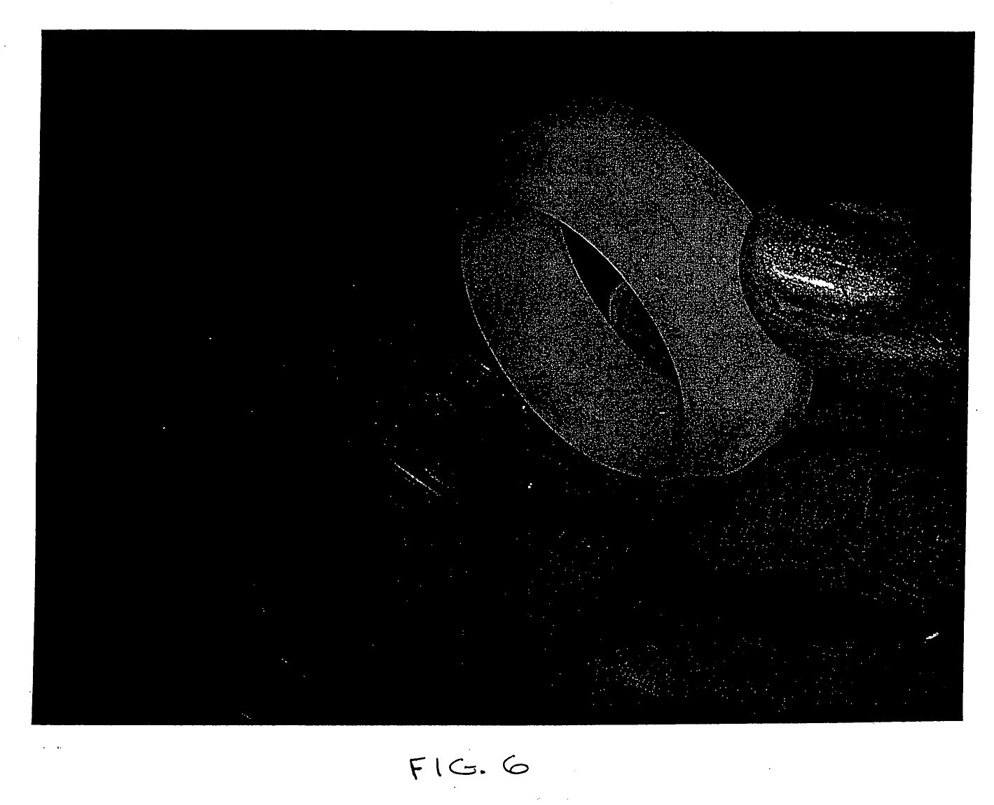

FIG. 7 shows the positioning of a plunger into the void left by the pedestal.

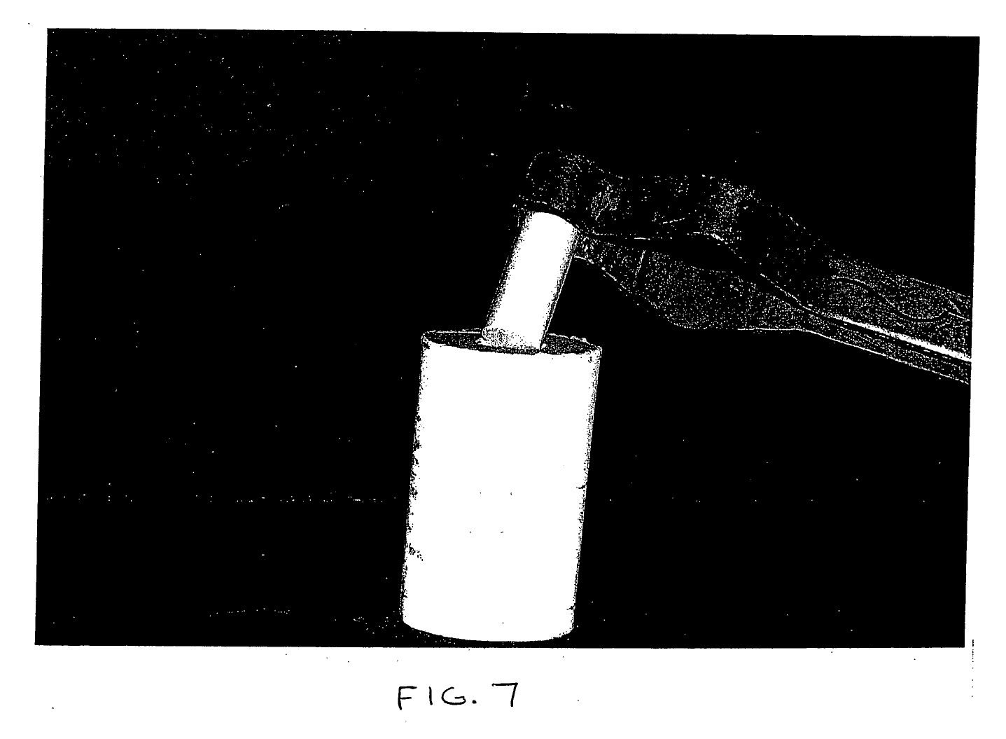

FIG. 8 shows the estimation of the level of the bottom of the plunger after ceramic is pressed into a mold.

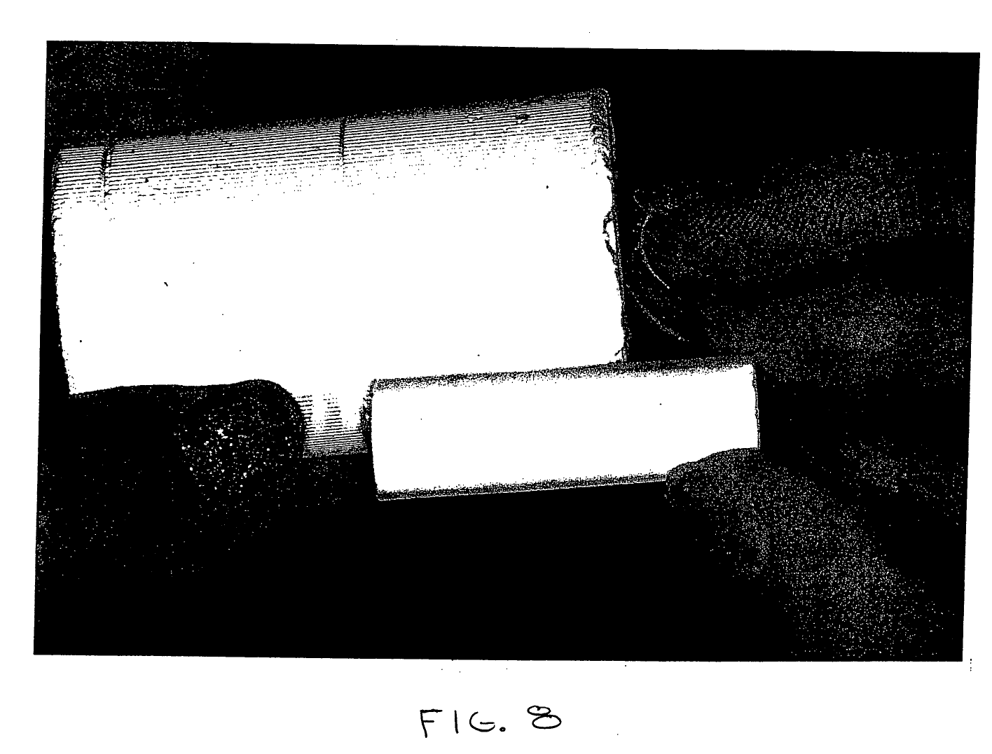

FIG. 9 shows the removal of a ceramic sprue from the final dental restoration.

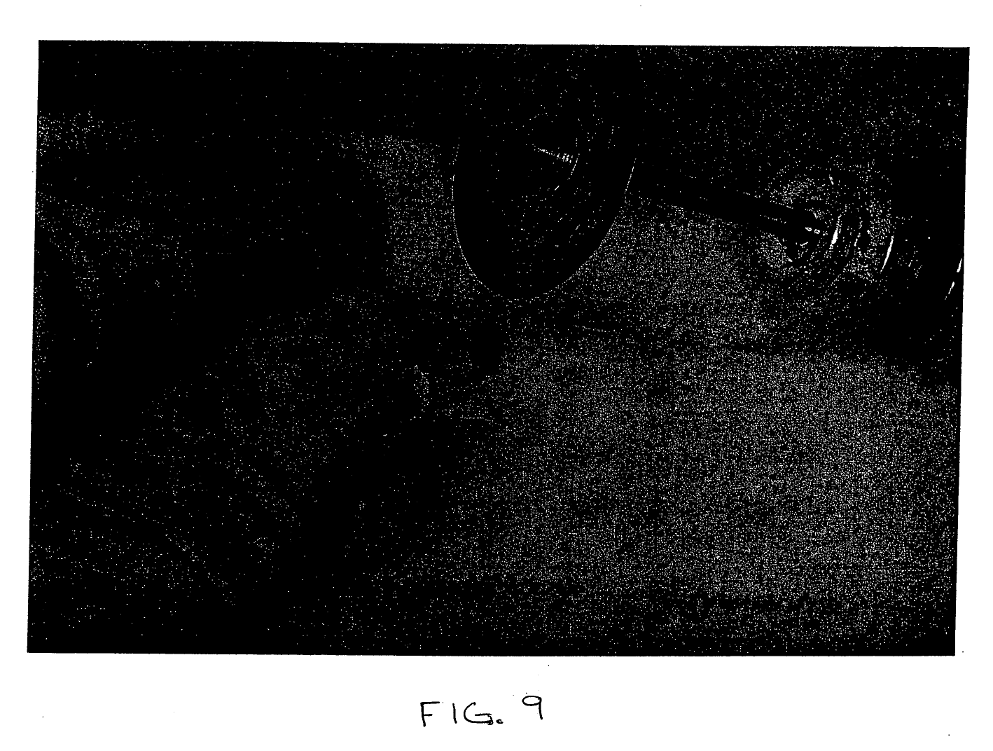

### DETAILED DESCRIPTION

The drawings and the following detailed descriptions show specific embodiments of the invention. Numerous specific details including materials, dimensions, and products are provided to illustrate the invention and to provide a more thorough understanding of the invention. However, it will be obvious to one skilled in the art that the present invention may be practiced without these specific details.

One embodiment of the invention is a method for forming pressable ceramic restorations including inlays, onlays, crowns, and veneers. The process is similar to that described above except that ceramic powder is used as the source of ceramic instead of a ceramic ingot. The powder may be provided to the void left by the pedestal by any method. The powder is then pressed into the refractory mold by the same method as described above. Preferably, the ceramic is porcelain. The porcelain powder is readily available from a variety of suppliers.

The desired amount of porcelain is calculated from a measurement of the weight of the wax model, in a similar manner the above described method of calculating the desired amount and size of porcelain ingots. Knowing the densities of the wax and the porcelain, one can easily calculate the desired weight of the porcelain from the following formula (which includes an optional additive term to provide porcelain at the very bottom of the pedestal void and ensure the sprues are completely filled):

$$porcelain wt . ( g ) = wax wt . ( g ) \times \frac{porcelain density ( g \text{/} {cm}^{3} )}{wax density ( g \text{/} {cm}^{3} )} + porcelain in pedestal tip ( g )$$

Using the porcelain described in U.S. Pat. No. 5,009,709, which is hereby incorporated by reference in its entirety, the present inventors used the following formula to determine the correct amount of porcelain based on the measured wax weight:
porcelain wt. (g)=wax wt. (g)×2.51+0.75 (g)

Optionally, the weight of the wax sprues may also be considered. In this case, the predetermined amount of the porcelain could be calculated based on a percentage of the weight of the sprues added to the weight of the model.

In one embodiment of the invention, a device is used to supply powder to the void left by the pedestal or pedestal void. The device comprises a tip connected to a source of vacuum and a handle. The calculated amount of powder is collected or sucked into the tip. The tip of the device is inserted into or positioned close to the pedestal void. The powder is then discharged from the tip into the pedestal void under positive pressure. The refractory mold may be vibrated to eliminate air between porcelain particles and thus slightly compact the porcelain powder. The powder may be added in a series of intakes and discharges or in a single discharge depending on the amount of porcelain needed and the capacity of the tip. The refractory mold may be under constant vibration during the entire powder supply step or the vibration may only occur after each addition of powder. The powder porcelain is then pressed into the restoration mold as described above for the ingot method. The formation and isolation of the restoration is then completed as above.

Any method may be used to supply the porcelain powder to the pedestal void, as the invention is not limited to the use of the device described above. For example, a hopper connected to a discharge nozzle could be used. The powder could also simply be added manually or poured into the void.

The present invention advantageously eliminates the need for the formation of porcelain ingots. As such, the present invention streamlines the entire restoration formation process and makes it less expensive. This allows porcelain restorations to be produced at high volume. The present invention further reduces the cost of porcelain restoration formation by reducing waste of porcelain. This is due to the fact that the exact amount of porcelain, based on the weight of the wax model, can be provided to the pedestal void. In the known method requiring porcelain ingots, the ingots are not formed to the exact specification of the amount of porcelain required and thus waste of porcelain occurs. Further, this wasted porcelain leads to increased time and cost required to divest the refractory mold from the porcelain restoration. For example, in the known method, the pressed porcelain typically fills at least the entire void left by the wax sprue and may overflow into the pedestal void. With the present invention, by accurately providing the correct amount of porcelain, the pressed porcelain may fill only a portion of the sprue void. Thus, less porcelain needs to be removed in order to isolate the final restoration.

The present invention also allows blends of different porcelain powders to be used in real time in restoration formation. This allows real time control of the color or shade of the porcelain in the final restoration. For example, powders of different color could be mixed together before being discharged into the pedestal void. Based on the color of the final restoration, a technician could then adjust the blend slightly to provide a restoration of a more desired color. This greatly reduces the cost of making restorations of several different shades of porcelain and provides the restoration formation process with greater flexibility and adaptability.

Although particular embodiments of this invention have been disclosed herein for purposes of explanation, further modifications or variations thereof will be apparent to those skilled in the art to which this invention pertains. Further, although porcelain is the primary material described for forming the dental restorations of the present invention, the present invention is not limited to the use of porcelain. Further, although certain processes have been described by a number of steps in a particular order, the present invention is not limited to any particular order. Further, those skilled in the art will recognize that many changes may be made to the lost wax technique without departing from the scope of the present invention. Thus, the scope of the present invention is not meant to be limited in any way.

What is claimed is:

1. A method for making a pressable porcelain restoration for a tooth, the method comprising:
forming a wax model of a tooth;
forming a refractory material structure around the wax model;
removing the wax model from the refractory material structure to form a void in the shape of the wax model within the refractory material structure;
pressing a predetermined amount of porcelain powder into the void to fill the void forming a porcelain powder compact in the shape of the void; and
removing the refractory material structure from around the porcelain powder compact to form a porcelain restoration.

2. A method for making a porcelain restoration of a desired shade, the method comprising:
providing a refractory material mold the shape of the restoration;
pressing a plurality of different colored porcelain powders into the mold to fill the mold with porcelain forming a polychromatic porcelain powder compact in the shape of the mold;
removing the refractory material from around the polychromatic porcelain powder compact to form a porcelain restoration of a desired shade.
